(19) United States
(12) Patent Application Publication
(10) Pub. No.: US 2015/0155062 A1
(43) Pub. Date: Jun. 4, 2015

(54) METHOD AND SYSTEM FOR INSPECTING A NUCLEAR FACILITY

(71) Applicant: SOLETANCHE FREYSSINET, Rueil Malmaison (FR)

(72) Inventor: Laurent Bindel, Palaiseau (FR)

(73) Assignee: SOLETANCHE FREYSSINET, Rueil Malmaison (FR)

(21) Appl. No.: 14/418,825

(22) PCT Filed: Jul. 26, 2013
(86) PCT No.: PCT/FR2013/051817

§ 371 Date: Jan. 30, 2015

(30) Foreign Application Priority Data
Aug. 1, 2012 (FR) 12 57505

(51) Int. Cl. G21C 17/00; G01T 1/167; G01T 1/20

(52) U.S. Cl. CPC G21C 17/00; G01T 1/20; G01T 1/167

(57) ABSTRACT

The method for inspecting a nuclear facility comprises the steps consisting of placing a radiation detector (2) in front of a surface of a portion of the facility (1), the radiation detector (2) being collimated to receive radiation from a cylindrical region of the portion of the facility; carrying out a plurality of measurements of radiation received by the radiation detector tar different transmission energies and different distances, along the axis of the cylindrical region, between the radiation detector and surface of the portion of the facility; and analysing the radiation measurements by subdividing the cylindrical region into a plurality of meshes (3) so as to estimate respective levels of radioactivity in the meshes (3).

The present invention relates to the techniques for inspecting nuclear facilities. It seeks to estimate the distribution of radioactive substances within the structure of the facility.

There are various methods for determining, in situ, the quantity of radionuclides in a nuclear facility. However the chief limitation of these methods lies in determining the depthwise distribution of these radionuclides, particularly in the concrete enclosures that form part of the facility. Knowledge of this distribution is essential to dismantling operations, for example so as to determine the thickness of material that has to be removed.

A distance-contrast method consists in taking two measurements at two distances from the environment that is to be characterized (a wall or floor for example) and then in exploiting the ratio between them. See A. Al-Ghamdi, and X. G. XU, “Estimating the Depth of Embedded Contaminants From in-Situ Gamma Spectroscopic Measurements”, Health Physics, Vol. 84, No. 5, May 2003, pp. 632-636. This first method is suitable for sources of defined geometry located near to the surface being inspected, but is not suitable for sources of unknown shape.

Another method uses the attenuation of two gamma rays. It assumes the existence of an isotope emitting two different energies. See M. Korun, et al., “In-situ measurements of the radioactive fallout deposit”, Nuclear Instruments and Methods in Physics Research, Vol. A300, No. 3, February 1991, pp. 611-615, or M. Korun, et al., “In-situ measurement of Cs distribution in the soil”, Nuclear Instruments and Methods in Physics Research, Vol. B93, No. 4, September 1994, pp. 485-491. That method allows only one depthwise parameter to be estimated. In addition, that approach assumes that the radionuclides have a uniform spatial distribution.

Patent U.S. Pat. No. 6,528,797 describes an angular method that can be applied to any material/environment provided that the attenuation properties thereof are negligible, known, measurable or can be estimated. The angular method allows a characterization of complex depthwise distributions. The depthwise distribution is calculated without a priori knowledge, without assumptions as to the shape, without the need to use additional invasive methods. The method is based on a differentiation in terms of angle and in terms of energy.

The current techniques do not make it possible to determine conveniently on site, quickly and precisely the depthwise radiological contamination in civil engineering constructions, for example a nuclear facility. Obtaining a three-dimensional map of the contamination present in the walls of the nuclear facility that has to be dismantled would be highly beneficial in order to optimize the at-source sorting of waste. This map could be directly connected to an official classification by listing activity per unit mass while at the same time evaluating the isotopic composition of the radioactive sources. Furthermore, locating and determining radioactive sources at a depth represent a sizeable problem in studies into radio protection during dismantling work. The existing methods remain too restrictive.

At the present time, spectrochemical analyses of elements taken as core samples are performed in the laboratory. These analyses involve specific costs and timescales and work in accordance with official regulations when putting together files to request authorization to transport them.

It is an objective of the present invention to propose a technique capable quickly and precisely of determining the depth of contamination in the case of voluminous sources of which the distribution is unknown or in the case of heterogeneous sources.

It is another objective of the present invention to propose an in situ and non destructive system and method for determining the depth of radiological contamination. That makes it possible correctly to evaluate the volume of waste in order to optimize the separation and classification of such waste.

There is proposed a method and a system for inspecting a nuclear facility. The method involves:
arranging a radiation detector in front of a surface of a portion of the facility, the detector being collimated to receive radiation from a cylindrical region of the portion of the facility;
taking several measurements of the radiation received by the radiation detector for different emission energies and different distances, along the axis of the cylindrical region, between the radiation detector and the surface of the portion of the facility; and
analyzing the radiation measurements by subdividing the cylindrical region into several meshes so as to estimate respective levels of radioactivity in the meshes.

The system comprises
a radiation detector collimated to receive radiation from a cylindrical region of a portion of the facility and to take several measurements of said radiation for different emission energies and different distances, along the axis of the cylindrical region, between the radiation detector and the surface of the portion of facility; and
an analyzer for analyzing the radiation measurements by subdividing the cylindrical region into several meshes so as to estimate respective levels of radioactivity in the meshes.

The radiation detector may notably be arranged in such a way that the cylindrical region has its axis perpendicular to the surface of the portion of facility.

In one embodiment, the meshes are slices of the cylindrical region which are subdivided perpendicular to the axis of the cylindrical region.

The analysis of the radiation measurements may involve an inversion of a linear system C·a=m, where:
m is a vector the components of which are the radiation measurements taken;
a is a vector the components of which are the levels of radioactivity that are to be estimated for the various meshes; and
C is a matrix, the components of which are values which are precalculated as a function:
   of the emission energies of the radiation in the measurements taken;
   of the distances, at the time of the measurements taken, between the radiation detector and the surface of the portion of facility; and
   of the times during which the radiation measurements are taken.

A regularization method may be applied to the inversion of the linear system.

One embodiment of the proposed system comprises a collimator associated with the radiation detector, adjustable so as to send to the detector only radiation coming from said cylindrical region, regardless of the chosen distance between the radiation detector and the surface of the portion of facility. The collimator may notably have a moving part and a fixed part allowing the detector a translational movement along the axis of the cylindrical region inside the collimator.

The system may further comprise a laser aiming device in order to ensure that the axis of the cylindrical region remains perpendicular to the surface of the portion of facility.

Other specifics and advantages of the present invention will become apparent in the following description of one nonlimiting embodiment, with reference to the attached drawings in which:

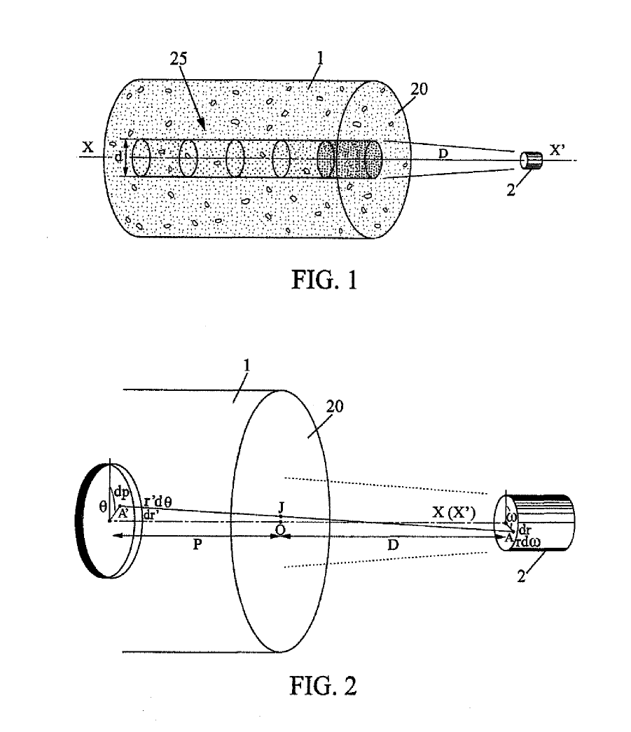

FIG. 1 is a perspective view schematically illustrating the principle according to the invention for inspecting a nuclear facility;

FIG. 2 illustrates the geometry of a model according to the invention to which reference may be made for estimating the levels of activity of a nuclear facility,

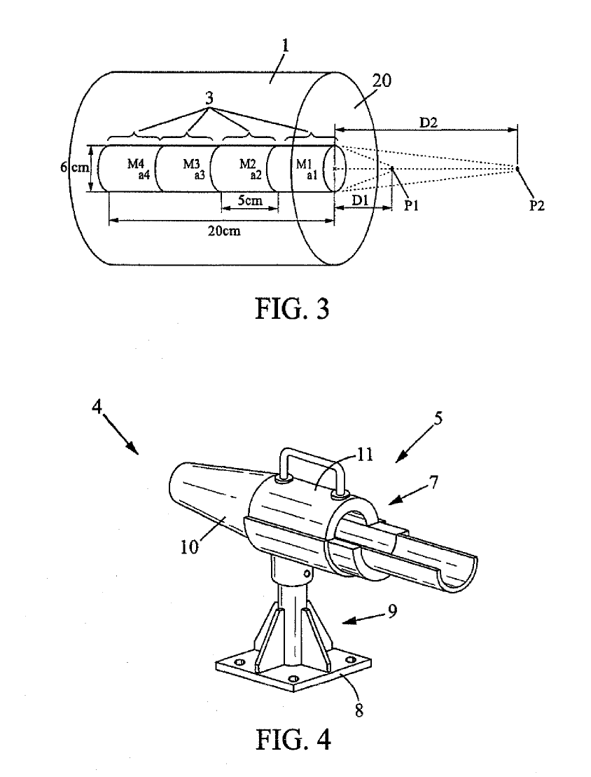

FIG. 3 shows one example of dimensional parameters that have been tested in order to validate the method of estimating the levels of activity according to the invention;

FIG. 4 is a perspective view of a system for inspecting a nuclear facility in an environment according to one preferred embodiment of the invention;

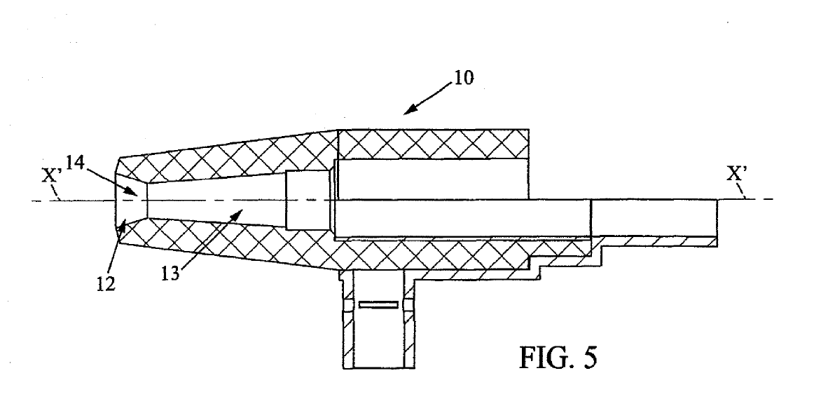

FIG. 5 is a view in section on X′ of the fixed part of the collimator of the embodiment illustrated in FIG. 4.

The method according to the invention uses a differentiation in terms of distance and in terms of energy in order to obtain radioactive profiles. It involves taking several measurements (two, three, four or even more) in an environment 1, at different distances D for several emission lines using a detection system comprising at least one radiation detector 2 (FIG. 1).

The “environment” referred to here is a portion of a nuclear facility containing radionuclides. This portion may form part of the floor or structural elements of a construction made of concrete or steel, said portion having been contaminated by radionuclides.

In order to take the measurements, the radiation detector 2 is arranged in front of a surface 20 of the environment 1. The radiation detector 2 is arranged in such a way that it receives radiation from a cylindrical region 25 of diameter d having its axis X perpendicular to the surface 20.

The radiation detector 2 is collimated to receive radiation coming from this same cylindrical region 25 whatever the distance D. The collimation is performed for example using a collimator made of lead, aligned with the axis X, which can therefore also be seen as being an axis X′ of the detection system.

Several measurements of the radiation received by the detector 2 are taken at different emission energies and for different distances D, along the axis X, between the radiation detector 2 and the surface 20 of the environment 1.

The measurements at different distances with respect to the surface 20 are taken by translating the radiation detector 2 parallel to its axis X′. The emission energies are preselected as a function of the spectrum of the radionuclides expected to be encountered in the structure, for example the lines for Europium 152 and/or 154 that can often be found in activated concrete.

The radiation measurements are analyzed using a processor that refers to a model according to which the cylindrical region examined is subdivided into several meshes of diameter d, for example having uniform thicknesses, so as to estimate respective levels of radioactivity in the meshes.

FIG. 2 illustrates the geometry of a model to which reference may be made in order to estimate levels of activity aᵢ according to the invention. The notation used is as follows:
O is the point situated at the intersection of the axis X′ of the radiation detector 2 with the surface 20 of the environment 1 that the radiation detector 2 is facing;
A is a point of the opening of the radiation detector 2, forming the center of a small element of surface area dS=r·dr·dω, where r and ω denote the polar coordinates of A in the sensitive plane of the detector 2 which is perpendicular to the axis X′;
A′ is the center of a small element of cylindrical volume dV belonging to the cylindrical region 25. This point A′ is situated at a depth p behind the surface 20 and at a distance r′ from the axis X (X′). Relative to the point of origin O and to the axis X (X′), the point A′ has the polar coordinates (p, r′, θ), and the elementary volume dV has the expression dV=r′·dr′·dθ·dp=dS′·dp, setting dS′=r′·dr′·dθ; and
J is the intersection between the segment extending from A′ to A and the surface 20.

The square of the distance A′A between the points A and A′ is given by:

A′A²=(D+p)²+(ρ·sin θ−r·sin ω)²+(ρ·cos θ−r·cos ω)² (1)

whereas the distance A′J between the points A′ and J is given by:

A′J=A′A×p/(D+p) (2)

The elementary flux δφ(E) of the gamma radiation at the emission energy E extending from the elementary volume dV around the point A′ to the elementary detector surface dS around the point A can be expressed as follows:

$$δφ ( E ) = \frac{{e}^{- μ ( E ) \cdot {A}^{′} J}}{4 π \cdot {A}^{′} {A}^{2}} \cdot dS \cdot {dS}^{′} \cdot dp \qquad ( 3 )$$

where μ(E), in units of cm⁻¹, is the coefficient of attenuation of the radiation in concrete at the energy E.

For a measurement at the distance D from the surface 20 of the environment 1, the number M_{D}(E) of events counted by the detector 2 at an energy E is expressed by:

$${M}_{D} ( E ) = ɛ ( E ) \cdot Y ( E ) \cdot {t}_{D} \cdot {\sum }_{i = 1}^{n} {a}_{i} \cdot {F}_{D , i}^{′} ( E ) \qquad ( 4 )$$

where: n is the number of meshes in the subdivision of the cylindrical region 25;

t_{D} is the duration of the measurement taken at the distance D;

ε(E) is the intrinsic efficiency of the detector 2 at the energy E;

Y(E) is the branching ratio for the emission ray of energy E;

aᵢ is the volumetric activity level of the mesh i, namely a quantity that is to be determined; and

F′_{D,i} is is an integral of flux for the cylindrical mesh i having the same diameter as the region 25 and extending from the depth to the depth pᵢ₋₁ and is given by:

$${F}_{D , i}^{′} ( E ) = {\int }_{{p}_{i - 1}}^{{p}_{i}} {\int }_{S} {\int }_{{S}^{′}} δφ ( E ) \qquad ( 5 )$$

By way of example, it is possible to subdivide the cylindrical region 25 of the concrete environment into n=4 meshes M1-M4 as illustrated in FIG. 3, and to take two measurements at two distances D₁, D₂ for two different energies E₁, E₂ of the gamma radiation. By setting:

F_{D,i}=ε(E)·Y(E)·F′_{D,i}·t_{D} (6)

the following matrix:

$$\underline{\underline{C}} = ( \begin{matrix}{F}_{{D}_{1 ,} 1} ( {E}_{1} ) & {F}_{{D}_{1 ,} 2} ( {E}_{1} ) & {F}_{{D}_{1 ,} 3} ( {E}_{1} ) & {F}_{{D}_{1 ,} 4} ( {E}_{1} ) \\ {F}_{{D}_{1 ,} 1} ( {E}_{2} ) & {F}_{{D}_{1 ,} 2} ( {E}_{2} ) & {F}_{{D}_{1 ,} 3} ( {E}_{2} ) & {F}_{{D}_{1 ,} 4} ( {E}_{2} ) \\ {F}_{{D}_{2 ,} 1} ( {E}_{1} ) & {F}_{{D}_{2 ,} 2} ( {E}_{1} ) & {F}_{{D}_{2 ,} 3} ( {E}_{1} ) & {F}_{{D}_{2 ,} 4} ( {E}_{1} ) \\ {F}_{{D}_{2 ,} 1} ( {E}_{2} ) & {F}_{{D}_{2 ,} 2} ( {E}_{2} ) & {F}_{{D}_{2 ,} 3} ( {E}_{2} ) & {F}_{{D}_{2 ,} 4} ( {E}_{2} )\end{matrix} ) \qquad ( 7 )$$

and the linear system:

C·a=m (8)

are introduced,
where: m=(M_{D}_{₁}(E₁), M_{D}_{₁}(E₂), M_{D}_{₂}(E₁), M_{D}_{₂}(E₂))^{T} is a vector the components of which are the radiation measurements M_{D}(E) taken;
a=(a₁, a₂, a₃, a₄)^{T} is a vector the components of which are the volumetric activity levels aᵢ to be estimated for the various meshes.

Studying the relationships (6), (5), (3), (2) and (1), it may be seen that the components F_{D,i} of the matrix C can be calculated in advance as a function:
of the values of μ(E₁), μ(E₂), of ε(E₁), ε(E₂) and of Y(E₁), Y(E₂) which are themselves known functions of the emission energies E₁, E₂ of the radiation used in the measurements;
of the distances D₁, D₂ between the detector 2 and the surface 20; and
of the times t_{D}_{₁}, t_{D}_{₂} during which the radiation measurements are taken.

Inverting the linear system (8) therefore makes it possible to estimate the radioactivity levels aᵢ from the measurements M_{D}(E).

The above method offers a great deal of freedom in the selection of the input parameters: meshing, measurement distances and energies. These are dependent on the situation encountered and on the method of resolution of the system.

The linear system (8) can be resolved in different ways. In order to do so, there must be no fewer independent measurements M_{D}(E) than there are unknowns aᵢ, so that the number of rows t of the matrix (t is the number of measurements, namely the number of measurement distances D multiplied by the number of energies E considered) is at least equal to its number of columns n. The illustrative example hereinabove sets l=n=4.

A direct method of resolving the linear system may be selected: generating the vectors aₖ, multiplying by the matrix C then selecting the corresponding mₖ values comparing them against the measurements using a norming criterion. The algorithm begins by setting the boundaries surrounding the space in which the solutions lie then by making a more or less discrete screening of that entire space.

A least-squares resolution technique is a convenient way of inverting the system (8). It consists in looking for the vector a that minimizes the norm ∥C·a−m∥². Conventionally, the solution is expressed in the form:

\hat{a}=(C^{T}·C)⁻¹·C^{T}·m (9)

In order to improve the stability of the solution found, recourse may in a known way be had to a regularization technique involving expressing the estimated activity levels vector \hat{a} as:

\hat{a}=(C^{T}·C+λ·Δ^{T}·Δ)⁻¹·C^{T}·m (9)

where: Δ is a diagonal matrix of size n×n, for example the identity matrix for a first order regularization; and

λ a regularization parameter, for example determined using what is referred to as the “L-Curve” method (see P.C. Hansen, “Analysis of discrete ill-posed problems by means of the L-curve”, SIAM Review, Vol. 34, No. 4, December 1992, pp. 561-580) which establishes a reliable compromise between the data fit and the regularization model via an L-curve.

FIG. 3 shows an example of dimensional parameters that have been tested in order to validate the method of estimating the activity levels. The source environment, for example a concrete wall 20 cm thick, has a cylindrical region 25 of 6 cm diameter subdivided discretely into four meshes 3 (M1-M4) of thickness pᵢ−pᵢ₋₁=5 cm. Each mesh is assumed to contain a mean volumetric activity aᵢ (i=1, 2, 3, 4). In order to restrict computation time, the radiation detector 2 has been likened to a point P (P1-P2) in the tests, this assumption not affecting the results obtained.

It is beneficial to have a fairly marked distance contrast while obtaining a significant measurement. The tests were conducted with two measurements taken at a first distance D₁=10 cm then at a second distance D₂=70 cm with measurement times T_{D}_{₁}=180 s and T_{D}_{₂}=5 T_{D}_{₁}=900 s. This choice notably made it possible to improve the conditioning of the matrix C. The rays for the isotopes 152 and 154 of Europium were used because these isotopes are often present in activated concretes. The above geometry leads to the creation of a square matrix C of rank four. Given that two measurements were set in place, it is necessary to use at least two emission rays at two different energies in order to be able to determine (in the mathematical sense of the term) the linear system. Use of three rays may be advantageous in allowing the system to be overdetermined.

Once the measurements have been taken in the cylindrical region 25, the equipment comprising the radiation detector 2 can be moved parallel to the structure in order to carry out a fresh estimate. A 3D map of the levels of radioactivity in the structure can thus be obtained.

The method offers a great deal of flexibility with the possibility to select the radiation emission energies, the meshing, the distances and the measurement times to suit the situation.

One option is to couple the above method, which uses photoelectric spikes, with a spectral method that takes the entire spectrum into consideration. The trough of the spike will differ according to the depth of the source (different attenuation); the spectrum will therefore be cleaned up and only the background used. The method gives an infinite number of pairs (intensity, depth) working on the rays, and the spectral method provides screening by working on the background, and therefore the pair (intensity, depth) to be considered.

FIG. 4 illustrates a system 4 according to the invention which comprises a detection equipment 5 and an analyzer (not depicted) incorporated into or connected to the equipment 5.

The detection equipment 5 comprises the radiation detector 2 (not visible in the view of FIG. 4), a collimator 7 in which the detector 2 is housed to receive the radiation emitted by the cylindrical region 25, a stand 9 and a base 8.

The radiation detector 2 may be a conventional scintillator of the LaBr₃ type, coupled with a photomultiplier. The collimator 7 arranged on the stand 9 is, for example, made of lead and steel in order to act as shielding for the radiation detector.

In one embodiment, the analyzer, for example a multiple channel analyzer, has a signal processor, a PCI interface connected to the radiation detector 2 and a display means for displaying the information connected with the measurements.

The data on the gamma radiation detected by the scintillator, amplified by the photomultiplier and analyzed by the multiple-channel analyzer are preferably conveyed by cable to a viewing device (display means), for example a PC containing spectral display software and the processing algorithm that allows the inversion to be performed. The latter makes it possible to reconstruct an image of the depthwise volumetric distribution of the volumetric activity distribution according to the method of the invention.

By moving the collimator 7 and the radiation detector 2 in the collimator, the detection equipment 5 is able to interrogate the same surface area whatever the distance between the environment to be characterized and the radiation detector 2. To make it easier to move the radiation detector 2 in the collimator 7, the latter contains a fixed part 10 fixed to the stand 9 and a moving part 11, for example a guide way on the top. The moving part 11 can slide on the fixed part 10 allowing the radiation detector 2 located inside the collimator 7 to effect translational movement. A vernier may be used to indicate the position of the detector in the collimator.

In order to interrogate a surface area that is the same irrespective of the distance between the environment to be characterized and the radiation detector, that is to say in order to obtain a property of “seeing” the same surface area at different distances back from the surface, the fixed part 10 of the collimator 7 is provided with an internal shape that can be broken down into two opposing cylindrical cones top to tail as illustrated in FIG. 5.

The diameter of an outer first cone 12 decreases and the diameter of an inner second cone 13 increases progressively toward the inside of the collimator. The oblique surface of the outer first cone 12 s more steeply inclined than that of the inner second cone 13, thus forming two asymmetric cones the inner second cone 13 of which is longer than the first cone 12. A throat 14 is formed between these two asymmetric cones.

In order for the attenuated radiation arriving at the radiation detector to be attenuated in the same way, provision may be made for the same thickness of shielding to be passed through irrespective of the angle of incidence of the radiation that is to be attenuated coming from the environment that is to be characterized.

A laser aiming system, for example, makes it possible to ensure that the detection equipment 5 remains perpendicular to the environment that is to be characterized.

Use of the technique proposed here reduces the time taken to characterize an environment and reduces the associated cost, as well as reducing the personnel exposure risk. The invention can be applied directly to clean up and dismantling work on vertical structures (walls) or horizontal structures (floors).

Naturally, the present invention can undergo numerous variations in its implementation. Although a number of embodiments have been described, it will be appreciated that it is inconceivable exhaustively to identify all possible embodiments. These embodiments described are mere illustrations of the present invention. Various modifications can be made without departing from the scope of the invention as emerges from the attached claims.

1. A method of inspecting a nuclear facility, comprising:
arranging a radiation detector in front of a surface of a portion of the facility, the radiation detector being collimated to receive radiation from a cylindrical region of the portion of the facility;
taking several measurements of the radiation received by the radiation detector for different emission energies and different distances, along the axis (X) of the cylindrical region, between the radiation detector and the surface of the portion of facility; and
analyzing the radiation measurements by subdividing the cylindrical region into several meshes so as to estimate respective levels of radioactivity in the meshes.

2. The method of claim 1, in which the radiation detector is arranged in such a way that the cylindrical region has its axis (X) perpendicular to the surface of the portion of facility.

3. The method of claim 1, in which the meshes are slices of the cylindrical region which are subdivided perpendicular to the axis (X) of the cylindrical region.

4. The method of claim 1, in which the analysis of the radiation measurements involves an inversion of a linear system C·a=m, where:
m is a vector the components of which are the radiation measurements taken;
a is a vector the components of which are the levels of radioactivity that are to be estimated for the various meshes; and
C is a matrix, the components of which are values which are precalculated as a function:
of the emission energies of the radiation in the measurements taken;
of the distances, at the time of the measurements taken, between the radiation detector and the surface of the portion of facility; and
of the times during which the radiation measurements are taken.

5. The method of claim 4, in which the inversion of the linear system involves the application of a regularization method.

6. The method of claim 1, in which the radiation received by the radiation detector comprises gamma radiation.

7. The method of claim 1, involving several measurements at different distances between the radiation detector and the surface of the portion of facility, for different respective emission energies.

8. A system for inspecting a nuclear facility, the system comprising:
a radiation detector collimated to receive radiation from a cylindrical region of a portion of the facility and to take several measurements of said radiation for different emission energies and different distances, along the axis (X) of the cylindrical region, between the radiation detector and a surface of the portion of facility; and
an analyzer for analyzing the radiation measurements by subdividing the cylindrical region into several meshes so as to estimate respective levels of radioactivity in the meshes.

9. The system of claim 8, comprising:
a collimator associated with the radiation detector, movable so as to send to the radiation detector only radiation coming from said cylindrical region, regardless of the chosen distance between the radiation detector and the surface of the portion of facility.

10. The system of claim 9, in which the collimator has a moving part and a fixed part allowing the radiation detector a translational movement along the axis of the cylindrical region inside the collimator.
